(19) United States
(12) Patent Application Publication
(10) Pub. No.: US 2022/0060144 A1
(43) Pub. Date: Feb. 24, 2022

(54) SOLAR PANEL RACK FOR A VEHICLE

(71) Applicant: Luke PHELPS, Kirksville, MO (US)

(72) Inventor: Luke PHELPS, Kirksville, MO (US)

(21) Appl. No.: 17/405,308

(22) Filed: Aug. 18, 2021

Related U.S. Application Data
(60) Provisional application No. 63/069,412, filed on Aug. 24, 2020.

(51) Int. Cl. H02S 30/10; B62D 63/08; B60L 8/00

(52) U.S. Cl. CPC H02S 30/10; B60L 2200/28; B60L 8/003; B62D 63/08

(57) ABSTRACT

A rack for mounting solar panels on a vehicle includes a framework that couples to and support the solar panels. The framework has opposite first and second sides and a width therebetween. A first framework support attaches to the vehicle. The first framework support includes a first framework connector that couples to the first side of the framework. A second framework support attaches to the vehicle at a location spaced apart from the first framework support. The second framework support couples to the second side of the framework. The first framework connector defines a first plurality of different coupling locations for the first side of the framework to couple to in order to accommodate the width of the framework when the first and second framework supports are attached to the vehicle.

### CROSS-REFERENCE TO RELATED APPLICATIONS

The present application claims priority to U.S. Provisional Application No. 63/069,412, filed Aug. 24, 2020, the entirety of which is hereby incorporated by reference.

### FIELD OF THE DISCLOSURE

The present disclosure generally relates to solar panel racks and, more particularly, to solar panel racks for mounting solar panels on vehicles.

### BACKGROUND OF THE DISCLOSURE

Vehicles, such as trailers, cars, trucks, shipping containers, rail cars, etc., are user to house and move a wide variety of different items, including items that may require electrical power. In order to provide the electrical power, some vehicles may include solar panels. In some embodiments, these solar panels can be mounted on the vehicle.

### SUMMARY OF THE DISCLOSURE

In one aspect, a rack for mounting one or more solar panels on a vehicle comprises a framework configured to couple to and support the one or more solar panels. The framework has opposite first and second sides and a width between the first and second sides. A first framework support is configured to attach to the vehicle. The first framework support includes a first framework connector configured to couple to the first side of the frame. A second framework support is configured to attach to the vehicle at a location spaced apart from the first framework support. The second framework support is configured to couple to the second side of the frame. The first framework connector is configured to be movable relative to the vehicle to accommodate the width of the framework when the first and second framework supports are attached to the vehicle.

In another aspect, a rack for mounting one or more solar panels on a vehicle comprises a framework configured to couple to and support the one or more solar panels. The framework has opposite first and second sides and a width between the first and second sides. A first framework support is configured to attach to the vehicle. The first framework support includes a first framework connector configured to couple to the first side of the framework. A second framework support is configured to attach to the vehicle at a location spaced apart from the first framework support. The second framework support is configured to couple to the second side of the framework. The first framework connector defines a first plurality of different coupling locations for the first side of the framework to couple to in order to accommodate the width of the framework when the first and second framework supports are attached to the vehicle.

In another aspect, a rack kit for mounting one or more solar panels on a vehicle comprising a first mounting base configured to be mounted to the vehicle. A second mounting base is configured to be mounted to the vehicle at a location spaced apart from the first mounting base. A plurality of framework connectors are configured to couple to either the first mounting base or the second mounting base. A plurality of solar panel supports are configured to be coupled to two of the plurality of framework connectors. A plurality of solar panel clips are configured to secure the one or more solar panels to the plurality of solar panel supports.

Other objects and features of the disclosure with be in part apparent and in part pointed out hereinafter.

### BRIEF DESCRIPTION OF THE DRAWINGS

FIG. 1 is a front perspective view of a trailer with an example rack supporting solar panels on the trailer;

FIG. 2 is a rear perspective view of the trailer shown in FIG. 1;

FIG. 3 is a front perspective view of the example rack;

FIG. 4 a cross-sectional view of the rack shown in FIG. 3 taken through line 4-4 of FIG. 3;

FIG. 5 is a cross-sectional view of the rack shown in FIG. 3 taken through line 5-5 of FIG. 3;

FIG. 6 is a perspective view a framework connector of the rack;

FIG. 7 is a perspective view a mounting base of the rack;

FIG. 8 is an exploded view of the rack;

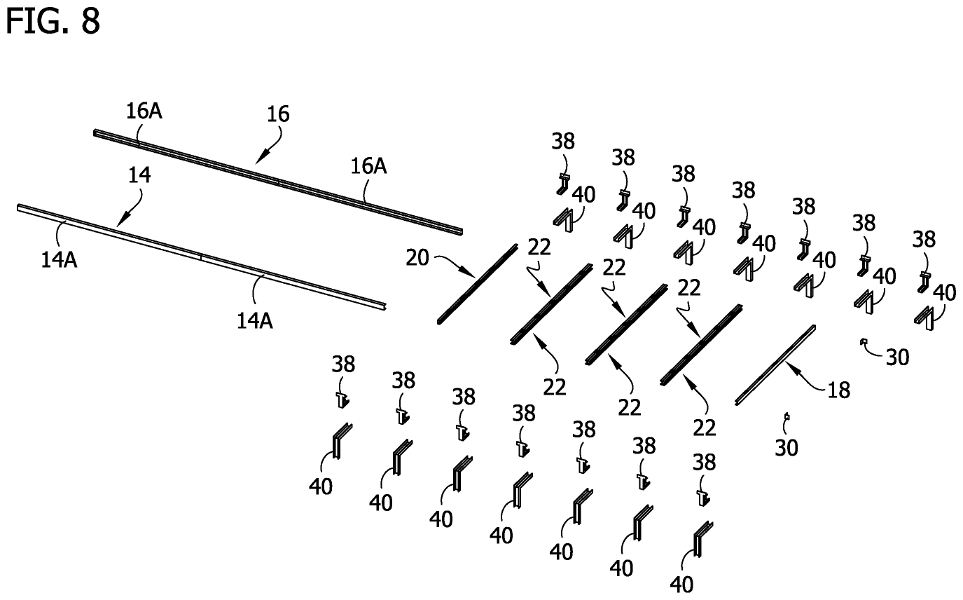

FIG. 9 is a perspective view of a trailer with another example rack supporting solar panels on the trailer;

FIG. 10 is a perspective view of the rack of FIG. 9;

FIG. 11 is an enlarged, detailed view of the rack of FIG. 9;

FIG. 12 is a cross-sectional view of the rack shown in FIG. 9 taken through line 12-12 of FIG. 10;

FIG. 13 is a perspective view of a mounting base of the rack of FIG. 9;

FIG. 14 is a perspective view of a framework connector of the rack of FIG. 9;

FIG. 15 is an exploded view of the rack of FIG. 9;

FIG. 16 is a perspective view of a trailer with another example rack supporting solar panels on the trailer;

FIG. 17 is a perspective view of the rack of FIG. 16;

FIG. 18 is an enlarged, detailed view of the rack of FIG. 16;

FIG. 19 is a cross-sectional view of the rack shown in FIG. 16 taken through line 19-19 of FIG. 17;

FIG. 20 is a perspective view of a framework connector of the rack of FIG. 16; and

FIG. 21 is an exploded view of the rack of FIG. 16.

Corresponding reference characters indicate corresponding parts throughout the drawings.

### DETAILED DESCRIPTION OF THE DISCLOSURE

The present disclosure generally relates to racks (e.g., solar panel racks) for mounting one or more solar or photovoltaic (PV) panels on a vehicle, such as a trailer (e.g., cargo trailers, box trailer, etc.), a truck (e.g., box truck, etc.), cars, shipping containers, rail cars or any other suitable powered or unpowered vehicle. The racks described herein can be configured and arranged to fit different sizes of vehicles. For example, the racks described herein can be configured and arranged to fit on vehicles having different lengths and/or widths.

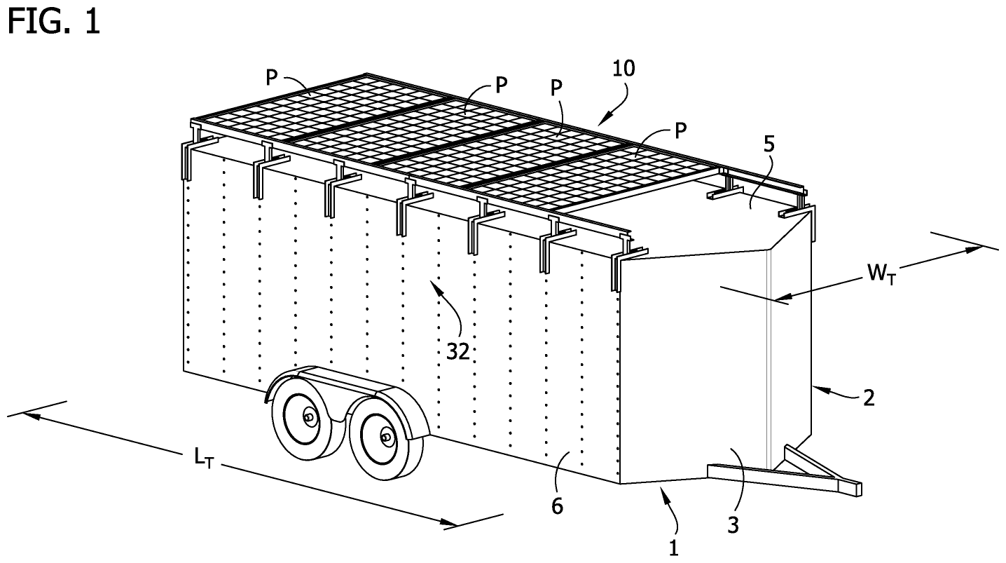

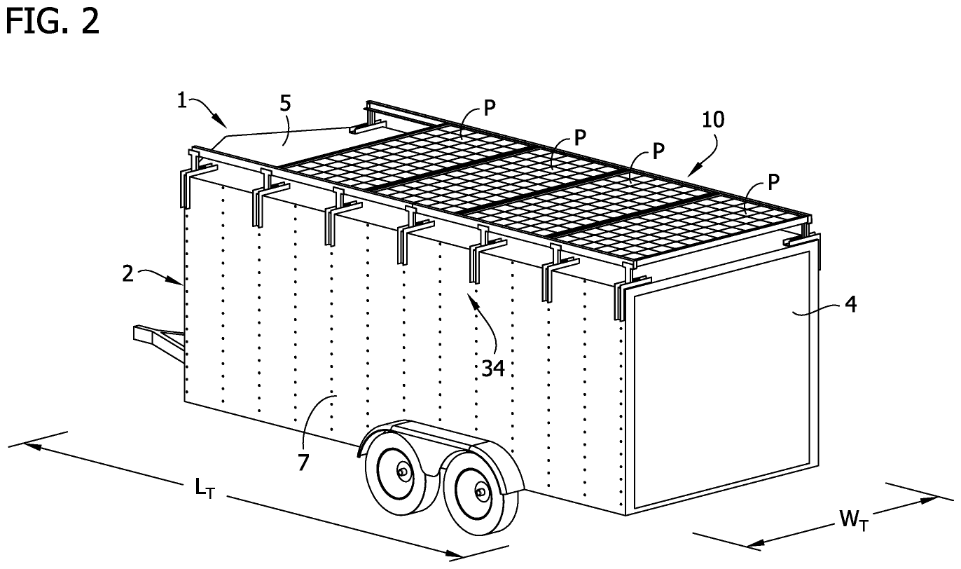

Referring to FIGS. 1-3, an example of a rack constructed according to the teachings of the present disclosure is generally indicated at reference numeral 10. The rack 10 supports and carries one or more solar panels P. However, it is understood the rack 10 disclosed herein can be used in other contexts without departing from the scope of the present disclosure. The rack 10 is mounted on or attached to a vehicle 1. In the illustrated embodiment, the vehicle 1 is a trailer. The vehicle 1 includes a housing 2 with a front end 3, a rear end 4, a roof 5 and first and second (e.g., left and right) sides 6, 7. The vehicle 1 has a width W_{T} between the first and second sides 6, 7. The vehicle 1 has a length L_{T} between the front and rear ends 3, 4. As shown, the rack 10 generally mounts to the roof 5 of the vehicle 1. As will be explained in more detail below, the rack 10 is selectively configurable to fit the size (e.g., length and width) of the vehicle 1 (e.g., trailer) the rack 10 is attached to. The rack 10, or more particularly a collection of its component parts, may be referred to as a “kit.”

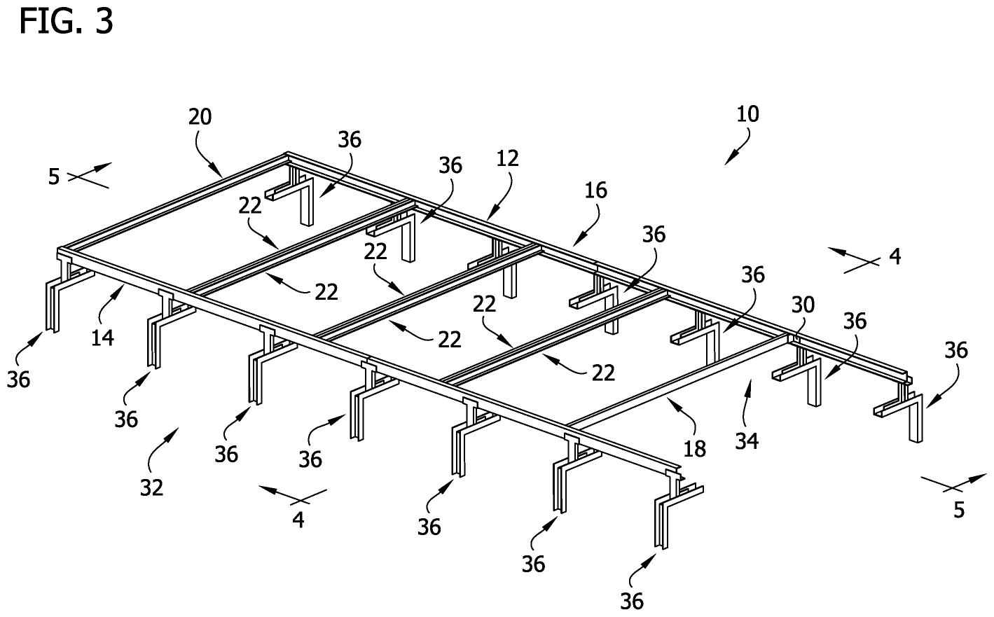

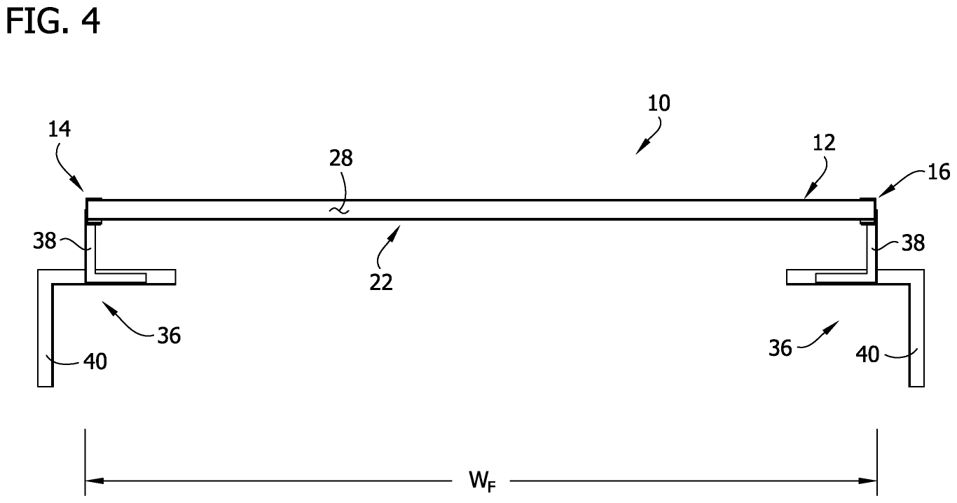

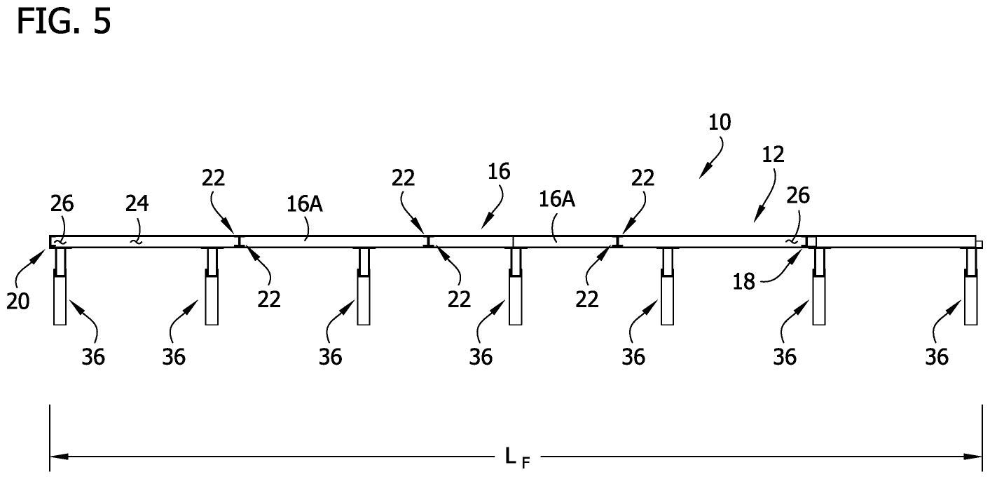

Referring to FIGS. 3-5, the rack 10 includes a framework 12 (e.g., a solar panel frame) configured to couple to and support the one or more solar panels P. In the illustrated embodiment, the framework 12 is configured to support four solar panels P although supporting more or fewer solar panels P are within the scope of the present disclosure. The framework 12 is generally rectangular and supports the solar panels P in a generally horizontal and co-planar manner. The framework 12 has opposite first and second sides. The framework 12 has a width W_{F} (FIG. 4) between the first and second sides. The width W_{F} of the framework 12 corresponds to (e.g., is generally the same as) a dimension of the solar panels P. In the illustrated embodiment, the solar panels P are arranged side-by-side such that the width W_{F} of the framework 12 corresponds to the length of a solar panel P. Accordingly, the width W_{F} of the framework 12 is generally set and fixed by the length of each solar panel P supported by the framework 12. The framework 12 has opposite front and rear ends and a length L_{F} (FIG. 5) between the front and rear ends. The length L_{F} of the framework 12 corresponds to the number of solar panels P supported by the framework 12. In the illustrated embodiment, the length L_{F} of the framework 12 is greater (broadly, greater than or equal to) than the combined width of the four solar panels P supported by the framework 12. Accordingly, the length L_{F} of the framework 12 is generally set by the number of solar panels P the framework 12 is to support and the width of those solar panels P. Solar panels P typically come in one of several standard sizes, such as about 77 inches by about 39 inches (length×width) or about 65 inches by about 39 inches. Other sizes for the solar panels P are within the scope of the present disclosure. The framework 12 can be configured (e.g., dimensioned) to support generally any size of solar panel P and generally any number of solar panels P. For example, in the illustrated embodiment, the framework 12 has a length L_{F} and a width W_{F} configured to support four solar panels P having as size of about 77 inches by about 39 inches. In other embodiments, framework 12 may have a length L_{F} to support other numbers of solar panels P (e.g., 2, 4, 6, 8, etc. solar panels) and/or a width W_{F} to support other sizes (e.g., lengths) of solar panels P.

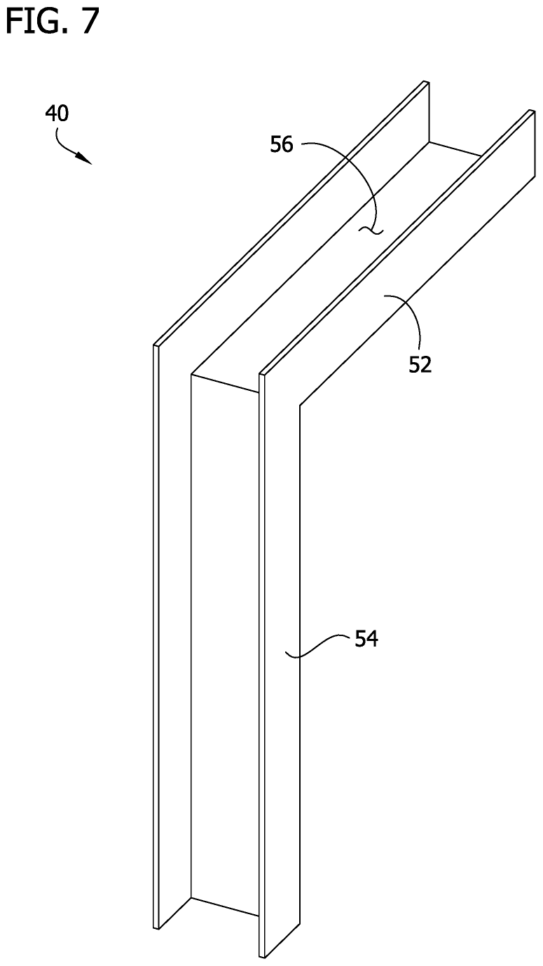

The framework 12 includes opposite first and second (e.g., left and right) side members (e.g., supports or rails) 14, 16 and opposite front and rear members (e.g., supports or rails) 18, 20 extending between the first and second side members 14, 16. The first and second side members 14, 16 are generally parallel to one another. The front and rear members 18, 20 are generally parallel to one another and generally orthogonal to the first and second side members 14, 16. The length L_{F} of the framework 12 extends between the ends of a side (either first or second) member 14, 16 and the width W_{F} of the framework 12 extends between the first and second side members 14, 16. In the illustrated embodiment, the first and second side members 14, 16 each include one or more side member portions 14A, 16A (FIG. 7). The side member portions 14A, 16A are attached end-to-end to form each side member 14, 16. The length of each side member 14, 16, and thereby the length L_{F} of the framework 12, can be adjusted by varying the number of side member portions 14A, 16A attached together. For example, removing side member portions 14A, 16A reduces the length of each side member 14, 16 and adding side member portions 14A, 16A increases the length of each side member 14, 16. Accordingly, the length L_{F} of the framework 12 can be adjusted to accommodate different numbers of solar panels P and/or different lengths L_{T} of vehicles 1. The framework 12 may also include one or more intermediate members (e.g., rails) 22 extending between the first and second side members 14, 16. Each intermediate member 22 is disposed between the front and rear members 18, 20. The intermediate members 22 are generally parallel to each other and to the front and rear members 18, 20. Each intermediate member 22 is generally orthogonal to the first and second side members 14, 16. Each intermediate member 22 is configured to be disposed between two adjacent solar panels P.

The framework 12 is configured to couple to and secure each solar panel P. In the illustrated embodiment, the first and second side members 14, 16, front and rear members 18, 20 and intermediate members 22 each receive an edge portion of each solar panel P coupled to the framework 12. Accordingly, the framework 12 generally encases each solar panel P to provide strength and support and keep the panels P secured while the vehicle 1 is moving. In the illustrated embodiment, the first and second side members 14, 16 each define a channel 24 (FIG. 5) sized and shaped to receive an edge portion (e.g., an end edge portion) of the solar panels P. In addition, the front and rear members 18, 20 each define a channel 26 (FIG. 5) sized and shaped to receive another edge portion (e.g., side edge portion) of the solar panels P. Likewise, each intermediate member 22 defines a channel 28 (FIG. 4) sized and shaped to receive another edge portion (e.g., side edge portion) of the solar panels P. In the illustrated embodiment, two intermediate members 22 are disposed between adjacent solar panels P, the two intermediate members 22 arranged back-to-back so that the channel 28 of one intermediate member 22 receives the edge portion of one of the solar panels P and the channel 28 of the other intermediate member 22 receive the edge portion of the other, adjacent solar panel P. In other embodiments, a single intermediate member that defines two channels on either side thereof may be disposed between adjacent solar panels P. In the illustrated embodiment, the first and second side members 14, 16, front and rear members 18, 20 and intermediate members 22 each have a generally C-shaped cross-section. The first and second side members 14, 16, front and rear members 18, 20 and intermediate members 22 may each be c-channel bar or strut made of metal (e.g., steel, stainless steel, aluminum, etc.). The ends of the front member 18, the rear member 20 and the intermediate members 22 are inserted into the channels 24 of the first and second side members 14, 16 to couple the front, rear and intermediate members 18, 20, 22 to the side members 14, 16. The first and second side members 14, 16, front and rear members 18, 20 and intermediate members 22 may be dimensioned to accommodate generally any size of solar panel P.

At least one of the front or rear members 18, 20 may be movable to adjust the distance between the front and rear members 18, 20. This allows the framework 12 to be configured to receive different numbers of solar panels P. For example, by moving the front and rear member 18, 20 closer together, the framework 12 of the illustrated embodiment could be arranged to carry three solar panels P, instead of the illustrated four solar panels P. In the illustrated embodiment, the front member 18 is movable relative to the rear member 20. The rear member 20 (e.g., ends thereof) are secured to (e.g., fixed to) the first and second side members 14, 16. The rear member 20 is secured adjacent to the rear ends of the first and second side members 14, 16. The rear member 20 may be secured to the side members 14, 16 with fasteners, by welding or any other suitable means. The front member 18 is movable to adjust the distance between the front and rear members 18, 20 to accommodate the number of solar panels P disposed therebetween. The framework 12 includes at least one keeper 30 configured to secure the front and rear members 18, 20 in position relative to one another. Specifically, the keeper 30 is configured to secure the front member 18 to the first and second side members 14, 16. In the illustrated embodiment, the framework 12 includes two keepers 30, one to secure each end of the front member 18 to the first and second side members 14, 16. In one embodiment, each keeper 30 includes a clamp (not shown) configured to move the front member 18 toward the rear member 20. This compresses the solar panels P between the front and rear members 18, 20 to further secure the solar panels P to the framework 12. In this embodiment, the intermediate members 22 may not be rigidly secured to the side members 14, 16 or rigidly secured (such as by fasteners) after the front member 18 is clamped in order to allow the intermediate members 22 to move as the solar panels P are compressed between the front and rear members 18, 20.

In one exemplary method of attaching the solar panels P to the framework 12, the solar panels are generally slid one after another along the channels 24 of the first and second side members 14, 16. For example, the rearward most solar panel P is slid first along the first and second side members 14, 16 until its edge portion is inserted into the channel 26 of the rear member 20. After, two (e.g., forward and rearward) intermediate members 22, arranged back to back (e.g., channels 28 facing away from each other), are slid along the first and second side members 14, 16 until the channel 28 of the more rearward intermediate member 22 receives the solar panel P. The next solar panel P is then slid rearward along the first and second side members 14, 16 until its edge portion is inserted into the channel 28 of the forward intermediate member 22. This process (e.g., the sliding of intermediate members 22 and solar panels P) repeats until all the solar panels P are positioned on the framework 12. Lastly, the front member 18 is slid along the first and second side members 14, 16 until the channel 26 of the front member 18 receives the edge portion of the forward most solar panel P. The keepers 30 are then used to secure the front member 18 to the first and second side member 14, 16, thereby securing the solar panels P to the framework 12.

Referring to FIGS. 3-7, the rack 10 includes first and second framework supports 32, 34 for attaching or mounting the framework 12 to the vehicle 1. Each framework support 32 is configured to attach to the vehicle 1 and to the framework 12. The first framework support 32 couples to a first side of the framework 12 and to generally the first side 6 (e.g., adjacent the first side) of the vehicle 1. The second framework support 34 couples to a second side of the framework 12 and to generally the second side 7 (e.g., adjacent the second side) of the vehicle 1. Thus, the first and second framework supports 32, 34 are configured to attach to the vehicle 1 at locations that are spaced apart from one another. Accordingly, the first and second framework supports 32, 34 support and connect opposite sides of the framework 12 to generally opposite sides of the vehicle 1.

The first and second framework supports 32, 34 are generally mirror images of one another. Each framework support 32, 34 includes a plurality of brace assemblies 36 (broadly, one or more brace assemblies). Each brace assembly 36 is configured to couple to the framework 12 and the vehicle 1 to mount the framework 12 on the vehicle 1. The brace assemblies 36 are all generally identical. Accordingly, one brace assembly 36 will now be described in further detail below with the understanding that all the brace assemblies 36 of the first and second framework supports 32, 34 have essentially the same construction. The brace assembly 36 includes a framework connector 38 and a mounting base 40. The framework connector 38 is coupled (e.g., movably coupled) to the mounting base 40. The framework connector 38 is configured to couple to the framework 12. In particular, the framework connector 38 is configured to couple to a side (e.g., the first side member 14 or the second side member 16) of the framework 12. The mounting base 40 is configured to couple to the vehicle 1. In particular, the mounting base 40 is configured to couple to the roof 5 of the vehicle 1 generally adjacent one side thereof. In the illustrated embodiment, the mounting base 40 is configured to couple to the roof 5 and either the first or second side 6, 7 of the vehicle 1.

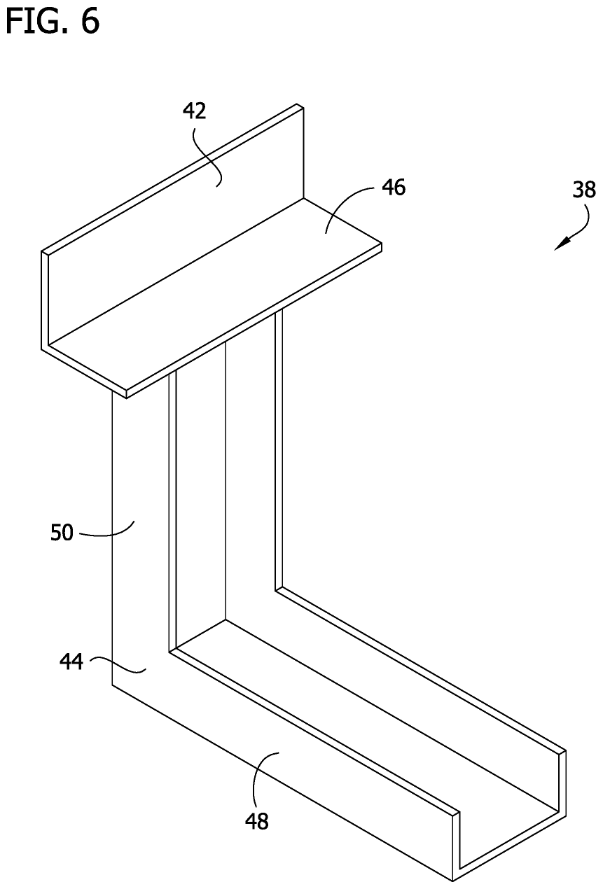

Referring to FIG. 6, the framework connector 38 includes a rest 42 and a leg 44. The rest 42 is configured to couple to and support the framework 12. The rest 42 includes a framework support surface 46 which engages and supports one of the first and second side members 14, 16. The rest 42 is rigidly coupled to the framework 12 (e.g., the first or second side member 14, 16). The rest 42 may be secured to the framework 12 with fasteners (not shown), by welding, or any other suitable means. In the illustrated embodiment, the rest 42 is an L-shaped metal (e.g., steel, aluminum, etc.) angle, although other configurations are within the scope of the present disclosure. The rest 42 is disposed at an upper end of the leg 44. The leg 44 has a generally L-shape with a generally horizontal member 48 and a generally vertical member 50. The horizontal member 48 of the leg 44 is movably coupled to the mounting base 40. The vertical member 50 of the leg 44 extends upward from an end of the horizontal member 48. The leg 44 (e.g., vertical member 50) spaces the framework 12 apart from the roof 5 of the vehicle 1 when the rack 10 is mounted on the vehicle 1. This spacing permits air to flow under and around the solar panels P in the framework 12 to provide cooling for the panels P. Generally, the warmer solar panels P become, the less efficient they are. Preferably, the leg 44 (broadly, the framework connector 38) has a height of about 4 inches to about 6 inches to space the framework 12 about 4 inches to about 6 inches from the roof 5 of the vehicle 1. In the illustrated embodiment, the leg 44 is a c-channel bar or strut with a 90-degree corner, although other configurations are within the scope of the present disclosure.

Referring to FIG. 7, the mounting base 40 has a generally L-shape with a first or roof member 52 and a second or side member 54. The roof member 52 is configured to engage and couple to the roof 5 of the vehicle 1 and the side member 54 is configured to engage and couple to one of the sides 6, 7 of the vehicle 1. The roof member 52 is generally horizontal and the side member 54 extends generally vertically downward from an end of the roof member 52. The mounting base 40 may be secured to the vehicle 1 with one or more fasteners (e.g., bolts) (not shown). In one embodiment, the mounting base 40 defines a recess (not shown) at an intersection of the roof and side members 52, 54. The recess is sized and shaped to receive a corner of the vehicle 1 defined by the roof 5 of the vehicle 1 and one of the sides 6, 7 of the vehicle 1. The recess permits the mounting base 40 to be mounted over a bead or flashing at the corner of the vehicle 1, with the recess accommodating the bead or flashing. In one embodiment, the mounting base 40 includes a sealer (not shown) configured to form a seal (e.g., a weather-tight seal) when the mounting base 40 is coupled to the vehicle 1. The sealer may be disposed on a lower surface of the roof member 52 that engages the roof 5 of the vehicle 1 and a side surface of the side member 54 that engages the side 6, 7 of the vehicle 1. The sealer may comprise a butyl putty or the like. In the illustrated embodiment, the mounting base 40 is a c-channel bar or strut with a 90-degree corner, although other configurations are within the scope of the present disclosure.

The framework connector 38 is movably coupled to the mounting base 40 and is movable relative to the mounting base 40 in order to accommodate the width W_{F} of the framework 12. Thus, the framework connector 38 is movable relative to the vehicle 1 to accommodate the width W_{F} of the framework 12 when the first and second framework supports 32, 34 are attached to the vehicle 1. In the illustrated embodiment, the mounting base 40 defines a channel 56. The channel 56 extends along both the roof member 52 and the side member 54. The framework connector 38 is movably mounted in the channel 56 of the mounting base 40 to accommodate the width W_{F} of the framework 12. The channel 56 is sized and shaped to receive the leg 44 (e.g., horizontal member 48) of the framework connector 38. The leg 44 of the framework connector 38 can slide in the channel 56. If the width W_{F} of the framework 12 is generally the same size as or smaller than the width W_{T} of the vehicle 1, then the framework connector 38 will preferably move in the portion of the channel 56 defined by the roof member 52. However, other configurations of the framework connector 38 are within the scope of the present disclosure that may be used to allow the framework connector to move in the portion of the channel 56 defined by the side member 54. For example, a framework connector may attach to the portion of the channel 56 defined by the side member 54 and extend outward from the side of the vehicle 1 to accommodate a width W_{F} of the framework 12 that is larger than the width W_{T} of the vehicle 1. The brace assembly 36 includes a keeper (not shown) configured to releasably secure the framework connector 38 to the mounting base 40. The keeper is releasable to permit the framework connector 38 to move to different locations on the mounting base 40 and secure the framework connector 38 in the different locations. In one embodiment, the keeper may be a fastener (e.g., a bolt).

As is apparent, the width W_{F} of the framework 12 is generally set by the size of the solar panels P. However, different vehicles 1 have different widths W_{T}. By moving the framework connector 38 relative to the vehicle 1 (e.g., the mounting base 40), the framework connector 38 can be positioned to connect to and support the framework 12, generally regardless of the location of the mounting base 40 on the vehicle 1. For example, the first and second framework supports 32, 34 are attached to the vehicle 1 by attaching each brace assembly 36 (e.g., mounting base 40) to the vehicle 1. The brace assemblies 36 of each framework support 32, 34 are spaced apart longitudinally along the vehicle 1. Preferably, the brace assemblies 36 of each framework support 32, 34 are disposed generally directly across from one another, as illustrated. Once the first and second framework supports 32, 34 (e.g., each brace assembly 36) are mounted on the vehicle 1, a user (e.g., installer) can move each framework connector 38 to accommodate the width W_{F} of the framework 12. The user can move the framework connectors 38 of each framework support 32, 34 toward or away from one another to conform the distance between the framework connectors 38 (e.g., corresponding framework connectors 38 of the first and second framework supports 32, 34) to the width W_{F} of the framework 12. Specifically, the user will move each framework connector 38 in the channel 56 of its associated mounting base 40 and then secure the framework connector 38 in position with the keeper. The movement of the framework connectors 38 enables the rack 10 to be mountable to vehicles 1 of generally any width W_{T}, regardless of the size of the framework 12.

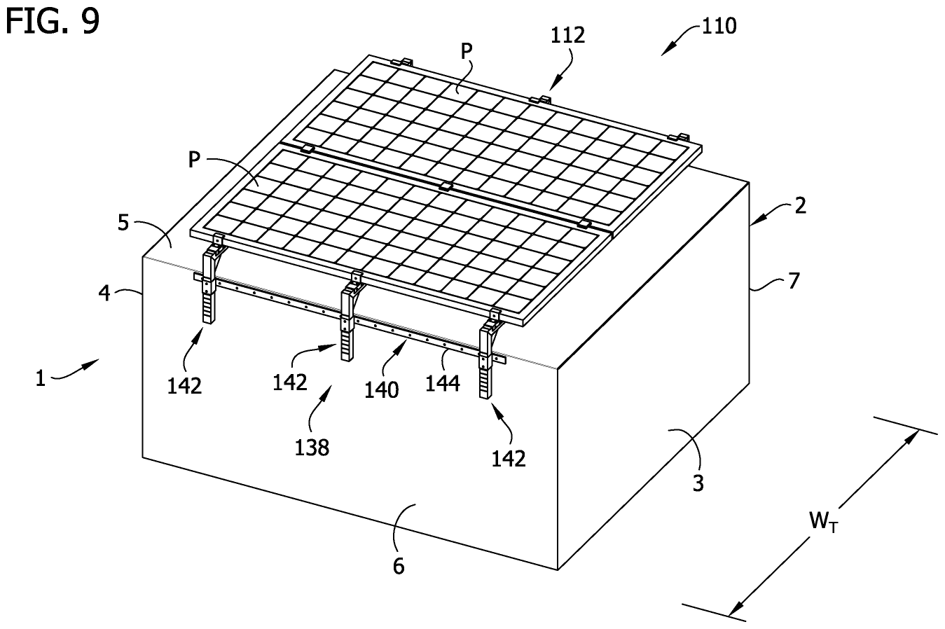

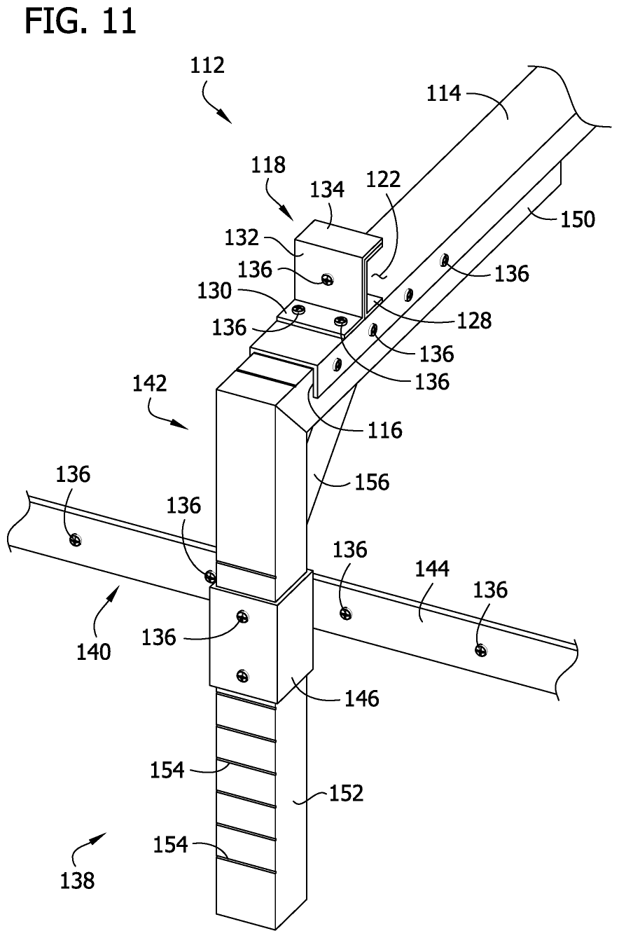

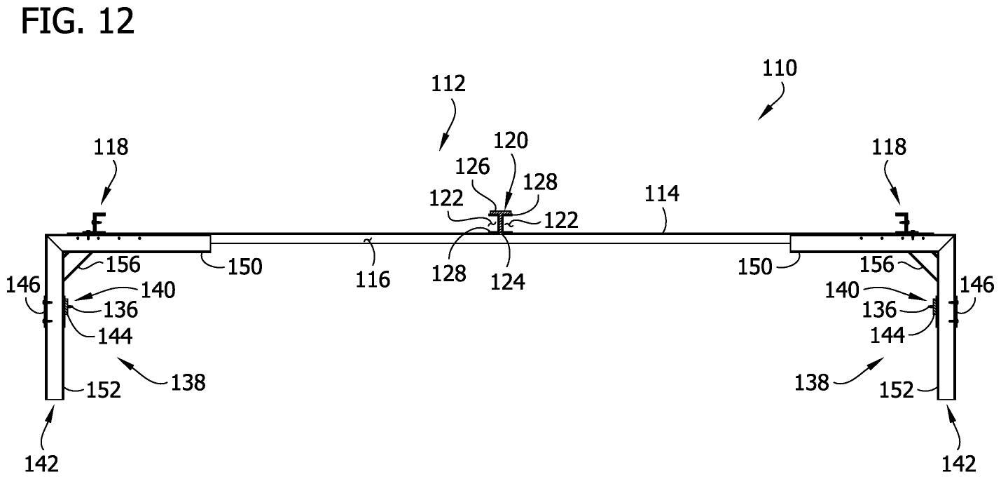

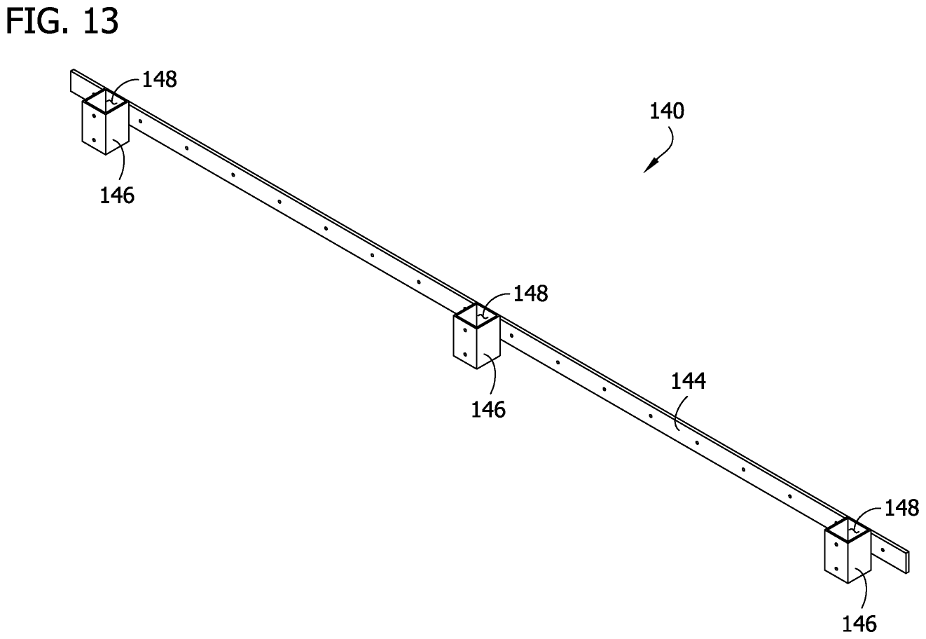

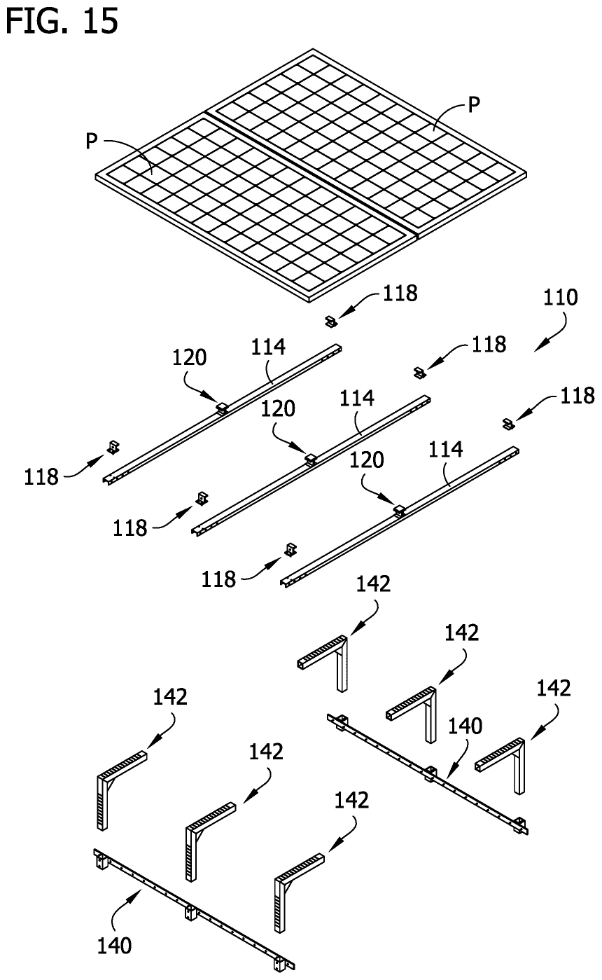

Referring to FIGS. 9-15, another example of a solar panel rack (e.g., rack) according to the teachings of the present disclosure is generally indicated at reference numeral 110. The rack 110 supports and carries one or more solar panels P. However, it is understood the rack 110 disclosed herein can be used in other contexts without departing from the scope of the present disclosure. In the illustrated embodiment, the rack 110 is mounted on or attached to the vehicle 1. As shown, the rack 110 generally mounts to the roof 5 of the vehicle 1. As will be explained in more detail below, the rack 110 is selectively configurable to fit the size (e.g., width) of the vehicle 1 (e.g., trailer) the rack 110 is attached to. The rack 110, or more particularly a collection of its component parts, may be referred to as a “kit.”

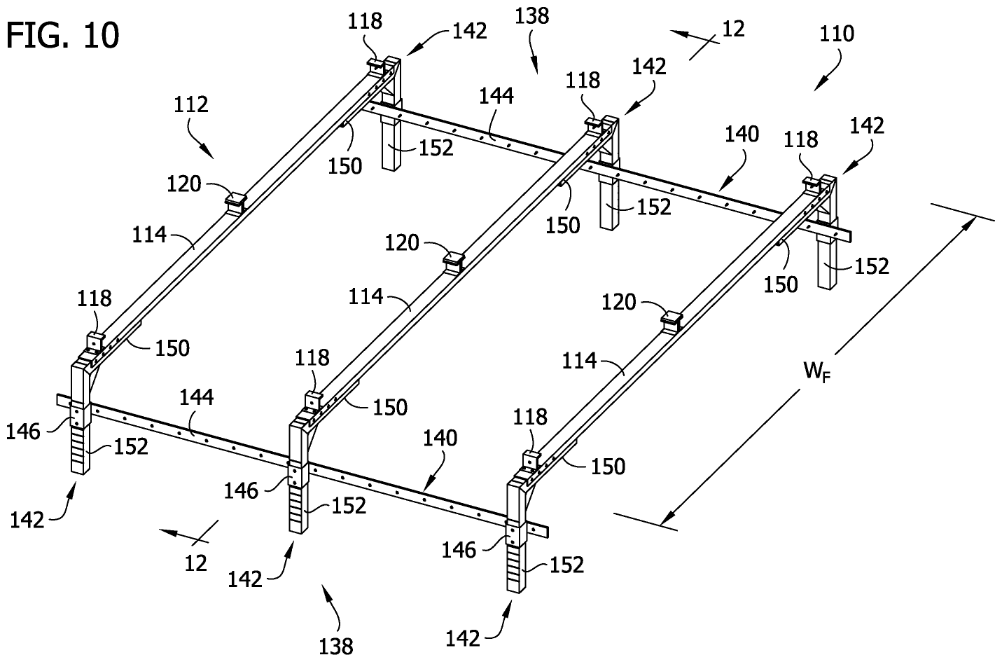

The rack 110 includes a framework 112 (e.g., a solar panel framework) configured to couple to and support the one or more solar panels P. In the illustrated embodiment, the framework 112 is configured to support two solar panels P although supporting more or fewer solar panels P are within the scope of the present disclosure. The framework 112 is generally rectangular and supports the solar panels P in a generally horizontal and co-planar manner. The framework 112 has opposite first and second sides. The framework 112 has a width W_{F} (FIG. 10) between the first and second sides. The width W_{F} of the framework 112 may be the same or different (e.g., smaller, larger) than the width W_{T} of the vehicle 1. The framework 112 can be configured (e.g., dimensioned) to support generally any size of solar panel P and generally any number of solar panels P. For example, in the illustrated embodiment, the framework 112 supports two solar panels P having as size of about 77 inches by about 39 inches. In other embodiments, framework 112 may support other numbers of solar panels P.

The framework 112 includes a plurality (broadly, at least one) of solar panel rails, members, or supports 114. Each solar panel support 114 is configured to support the solar panels P (broadly, at least one solar panel P). The solar panel supports 114 generally extending between the first and second sides of the framework 112. In the illustrated embodiment, the width W_{F} of the framework 112 extends between the opposite ends of solar panel supports 114. The solar panel supports 114 are generally parallel to one another. Each solar panel support 114 defines a channel 116. The channel 116 extends along the length of the solar panel support 114. In the illustrated embodiment, the solar panel supports 114 each have a generally C-shaped cross-section. The solar panel supports 114 may each be c-channel bar or strut made of metal (e.g., steel, stainless steel, aluminum, etc.).

The framework 112 is configured to couple to and secure each solar panel P. Specifically, each solar panel support 114 is configured to be coupled and secured to a solar panel P (broadly, at least one solar panel P). The framework 112 (broadly, the rack 110) includes one or more solar panel clips. Each solar panel clip is configured to engage a solar panel P (broadly, at least one solar panel P) to secure the solar panel P to the framework 112, specifically the solar panels supports 114. Each solar panel clip receives an edge portion of the solar panel P. In the illustrated embodiment, the framework 112 includes two types of clips, an adjustable solar panel clip 118, and a fixed solar panel clip 120. Each fixed solar panel clip 120 is fixedly mounted on one of the solar panel supports 114 of the framework 112. In the illustrated embodiment, each fixed solar panel clip 120 secures two solar panels P (broadly, at least one solar panel P) to the framework 112. Each fixed solar panel clip 120 defines first and second solar panel receiving spaces 122 one generally opposite sides of the fixed solar panel clip 120. Each solar panel receiving space 122 is sized and shaped to receive one solar panel P (e.g., an edge portion or margin thereof). In the illustrated embodiment, the fixed solar panel clip 120 has a generally T-shape, with a base flange 124 attached to (such as by welding) the solar panel support 114 at one end of the base flange 124 and a cross flange 126 attached to the solar panel support 114 at the other end. The fixed solar panel clip 120 includes first and second pads 128. Each pad 128 is generally C-shaped and extends along the solar panel support 114, the base flange 124 and the cross flange 126. Each pad 128 defines one of the solar panel receiving spaces 122. The pads 128 engage and cushion the solar panel P when the fixed solar panel clip 120 secures the solar panel P to the framework 112. The pads 128 provide cushioning for the solar panels P when the solar panels P are mounted on the framework 112. Other configurations of the fixed solar panel clip are within the scope of the present disclosure. For example, in one embodiment, the fixed solar panel clip may comprise the cross flange and one or more fasteners extending through the cross flange to secure the cross flange to the solar panel support 114. This allows the cross flange to be clamped down onto the solar panels P, by tightening the one or more fasteners. In this embodiment, the fixed solar panel clip may include one or more fastener receivers extending up from the solar panel support, with each fastener receiver threadably coupling to one of the fasteners.

The adjustable solar panel clips 118 are configured to be connected to (e.g., mounted on) the solar panel supports 114. In particular, each adjustable solar panel clip 118 is configured to be connected to one of the solar panel supports 114 at a plurality of different positions on the solar panel support to accommodate the size of the solar panel P. In the illustrated embodiment, each solar panel P is secured to the framework 112 with at least one adjustable solar panel clip 118 and at least one fixed solar panel clip 120. The user is able to move the adjustable solar panel clip 118 to different positions on the solar panel support 114 to mount the adjustable solar panel clip 118 that matches the size of a particular solar panel P. Accordingly, the framework 112 can be coupled to solar panels P of different sizes by mounting the adjustable solar panel clips 118 on the framework 112 that correspond to the dimensions (e.g., width) of the solar panels P. In the illustrated embodiment, each adjustable solar panel clip 118 secures one solar panel P (broadly, at least one solar panel P) to the framework 112. Each adjustable solar panel clip 118 defines a solar panel receiving space 122. The solar panel receiving space 122 of the adjustable solar panel clip 118 is sizes and shaped to receive one solar panel P (e.g., an edge portion or margin thereof). In the illustrated embodiment, the adjustable solar panel clip 118 has a generally Z-shape, with a base flange 130, an intermediate flange 132, and a top flange 134. The base flange 130 defines one or more openings that receive fasteners 136 (such as bolts, self-tapping screws, etc.) that secure the adjustable solar panel clip 118 to the framework 112. In the illustrated embodiment, the fasteners 136 are self-tapping screws, which allow the adjustable solar panel clip 118 to be secured to the solar panel support 114 at generally any position thereon. The intermediate flange 132 may also define an opening that receives a fastener 136 that secures the solar panel P to the adjustable solar panel clip 118. The adjustable solar panel clip 118 includes a pad 128. The pad 128 of the adjustable solar panel clip 118 is generally C-shaped and extends along the solar panel support 114, the top flange 134 and the intermediate flange 132. The pad 128 defines the solar panel receiving space 122. The pad 128 engages and pads the solar panel P when the adjustable solar panel clip 118 secures the solar panel P to the framework 112. The pad 128 provides cushioning for the solar panel P when the solar panel P is mounted on the framework 112. In the illustrated embodiment, the adjustable solar panel clips 118 are disposed on one side of each solar panel P and the fixed solar panel clips 120 are disposed on the opposite side of each solar panel P. Thus, the solar panel clips 118, 120 generally clamp the solar panel P therebetween to secure the solar panel P. In the illustrated embodiment, three adjustable solar panel clips 118 and three fixed solar panel clips 120 are used to secure each solar panel P to the framework 112, although more or fewer solar panel clips 118, 120 are within the scope of the present disclosure.

Other configurations of the adjustable solar panel clip are within the scope of the present disclosure. For example, in one embodiment, the solar panel support and/or the rest of the framework connector (described in more detail below) define a slot therealong. In this embodiment, the adjustable solar panel clip includes a clamp underlying the slot and one or more fasteners extending through the base flange, through the slot and into the clamp. In this embodiment, tightening the fasteners brings the clamp into engagement with an underside of the solar panel support and/or the rest of the framework connector to secure (e.g., clamp) the adjustable solar panel clip in one of a plurality of positions defined by the solar panel support and/or the rest of the framework connector. Loosening the fasteners releases the clamp and allows the adjustable solar panel clip to slide along the slot to move the adjustable solar panel clip to a position that conforms to the size of the solar panels P. Alternatively or in addition to, in one embodiment, the adjustable solar panel clip can be height adjustable. For example, the adjustable solar panel clip can include an L-shaped first portion having the top flange and a first intermediate flange extending therefrom and an L-shaped second portion having the base flange and a second intermediate flange extending therefrom. A fastener, such as a self-tapping screw, may be used to secure the first and second intermediate flanges together. By adjusting the position of the first and second intermediate flanges relative to one another before they are secured together, the height of the adjustable solar panel clip (e.g., the position of the top flange) can be set to conform to the height of the solar panel P.

In one exemplary method of attaching the solar panels P to the framework 112, each solar panel P is generally slid into engagement with the fixed solar panel clips 120. For example, the one solar panel P is slid generally laterally along the solar panel supports 114 until its edge portion is inserted into the solar panel receiving space 122 and engages the pad 128 of the fixed solar panel clips 120. After, each adjustable solar panel clip 118 positioned on the solar panel supports 114 to engage the solar panel P, such that another edge portion of the solar panel P is disposed in the solar panel receiving space 122 and engages the pad 128 of the adjustable solar panel clip 118. Then, the fasteners 136 are inserted through the base flange 130 and into the solar panel support 114 to secure the adjustable solar panel clip 118 in position. Another fastener 136 may also be inserted through the intermediate flange 132 and into the solar panel P to further secure the solar panel P to the framework 112.

Still referring to FIGS. 9-15, the rack 110 includes first and second framework supports 138 for attaching or mounting the framework 112 to the vehicle 1. The first and second framework supports 138 are generally identical (e.g., are mirror images of one another). Each framework support 138 is configured to attach to the vehicle 1 and to the framework 112. The first framework support 138 couples to a first side of the framework 112 and to generally the first side 6 (e.g., adjacent the first side) of the vehicle 1. The second framework support 138 couples to a second side of the framework 112 and to generally the second side 7 (e.g., adjacent the second side) of the vehicle 1. Thus, the first and second framework supports 138 are configured to attach to the vehicle 1 at locations that are spaced apart from one another. Accordingly, the first and second framework supports 138 support and connect opposite sides of the framework 112 to generally opposite sides of the vehicle 1.

Each framework support 138 includes a mounting base (e.g., a vehicle mounting base) 140 and a plurality (broadly, two or more) of framework connectors 142. The mounting base 140 is configured to couple to (e.g., mounted on) the vehicle 1. The mounting member 140 includes a vehicle mounting member 144 (e.g., a vehicle mounting member) configured to be coupled to an exterior surface of the vehicle 1. The vehicle mounting member 144 can be coupled to generally any exterior surface of the vehicle 1 such as roof 5 of the vehicle or a side 6, 7 of the vehicle. In the illustrated embodiment, the vehicle mounting member 144 is mounted on a side 6, 7 of the vehicle 1. The illustrated vehicle mounting member 144 is generally an elongate strip. The vehicle mounting member 144 defines a plurality of fastener openings that receive fasteners 136 (e.g., bolts, self-tapping screws, etc.) to secure the vehicle mounting member 144 to the vehicle 1. Preferably, the mounting base 140 includes a sealer (not shown) configured to form a seal (e.g., a fluid or weather tight seal) with the vehicle 1 when the mounting base 140 is coupled to the vehicle 1. The sealer can be disposed on the vehicle mounting member 144 (e.g., a side surface thereof) and arranged to engage the vehicle 1 when the vehicle mounting member 144 is secured to the vehicle 1 with the fasteners 136. The sealer inhibits moisture from entering the vehicle 1 through the connection made by the vehicle mounting member 144 on the vehicle 1. The sealer may comprise a butyl putty or the like.

The framework connectors 142 are configured to be connected to the mounting base 140. The mounting base 140 includes a plurality (broadly, two or more) of framework connector receivers 146. Each framework connector receiver 146 is configured to receive and connect to one of the framework connectors 142. The framework connector receiver 146 is connectable to the framework connector 142 at a plurality of different positions on the framework connector 142. Each framework connector receiver 146 defines an opening 148. The opening 148 is sized and shapes to receive the framework connector 142 and allow the framework connector 142 to move (e.g., slide) therein. This allows the framework connector 142 to move relative to the framework connector receiver 146 to connect the framework connector receiver 146 to the framework connector 142 at one of the different positions. Each framework connector receiver 146 is connected (e.g., attached) to the vehicle mounting member 144. The framework connector receivers 146 are spaced apart along the vehicle mounting member 144. The framework connector receivers 146 are positioned on the vehicle mounting member 144 to generally correspond to the size (e.g., length) of the solar panels P being mounted by the rack 110. As is apparent, the position of the framework connector receivers 146 sets the position of the solar panel supports 114 of the framework 112. In the illustrated embodiment, the mounting base 140 includes three framework connector receivers 146. The three framework connector receivers 146 are positioned so that two solar panel supports 114 will support opposite ends of the solar panels P and the other solar panel support 114 will support the middle of the solar panels P. More or fewer framework connector receivers 146 (and thereby framework connectors 142 and solar panel supports 114) are within the scope of the present disclosure.

Each framework connector 142 is configured to couple (e.g., attach) to the framework 112. In particular, each framework connector 142 is configured to be coupled (e.g., attached) to a side (e.g., the first side or the second side) of the framework 112. Each framework connector 142 defines a plurality of different coupling locations for the framework 112 to couple to in order to accommodate the width W_{F} of the framework 112 when the first and second framework supports 138 are attached to the vehicle 1. By providing a plurality of different coupling locations on each framework connector 142, the framework 112 is able to be connected to the first and second framework supports 138 generally regardless of the dimensions (e.g., width W_{T}) of the vehicle 1. This allows the rack 110 to be installed on vehicles 1 of different sizes (e.g., dimensions).

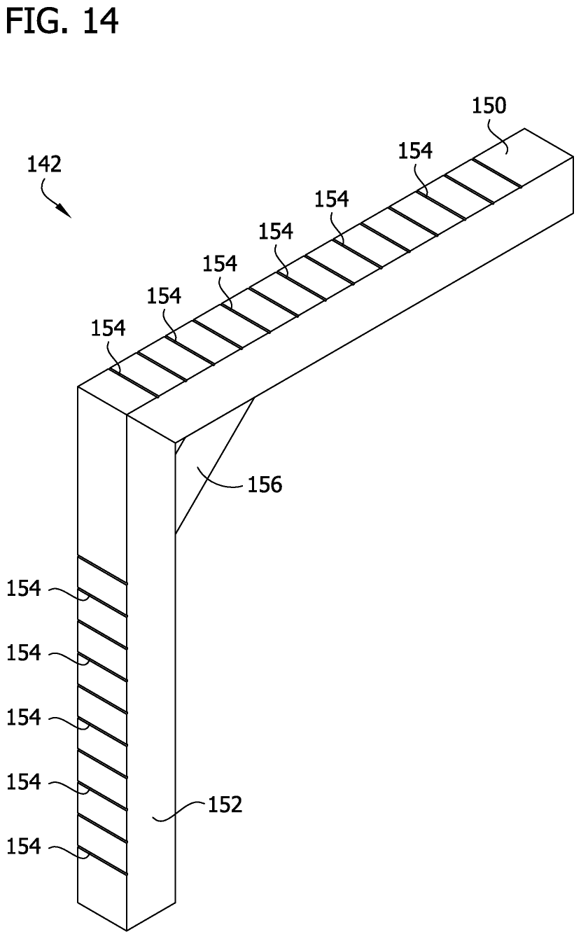

Referring to FIG. 14, the illustrated framework connector 142 has a generally L-shape with a rest 150 and a leg 152. The rest 150 is arranged to connect to and support the framework 112. The rest 150 includes an upper surface which engages and supports one of the solar panel supports 114. The rest 150 is generally elongate and defines the plurality of different coupling locations. The rest 150 is sized and shaped to be received by the channel 116 of a solar panel support 114 of the framework 112. In other words, the channel 116 is sized and shaped to receive the rest 150 (broadly, the framework connector 142) when the solar panel support 114 is connected to the framework connector 142. The framework 112, specifically the solar panel support 114, can move (e.g., slide) relative to the rest 150 to accommodate the width W_{F} of the framework 112 when the first and second framework supports 138 are attached to the vehicle. The rest 150 can slide within the channel 116, allowing the framework 112 to move to one of the different positions on the rest 150. In the illustrated embodiment, the rest 150 includes indicia 154 (e.g., lines) at equally spaced intervals there along. The indicia 154 provides a reference for the user on the rest 150 so that the use can properly position the framework 112 on the rest 150 (e.g., center the framework 112 on between the first and second framework supports 138). The rest 150 is rigidly coupled to the framework 112 (e.g., the solar panel support 114). The rest 150 may be secured to the framework with fasteners 136 (e.g., self-tapping screws), as shown, or by welding, or any other suitable means. The fasteners 136 allow the solar panel support 114 to be secured to the rest 150 at generally any position thereon. In the illustrated embodiment, the rest 150 comprises a length of metal (e.g., steel, aluminum, etc.) tubing, although other configurations are within the scope of the present disclosure.

The rest 150 is disposed at an upper end of the leg 152. The rest 150 is generally horizontal and the leg 152 extends generally vertically downward from the rest 150. The leg 152 is sized and shaped to be inserted into the opening 148 of the framework connector receiver 146. The leg 152 can move (e.g., slide) within the opening 148 of the framework connector receiver 146 to connect the framework connector receiver 146 to the framework connector 142 (e.g., leg 152) at one of the plurality of different positions. Moving the leg 152 of the framework connector 142 relative to the framework connector receiver allows the distance between the framework 112 and the roof 5 of the vehicle to be adjusted. This allows the framework 112 to be spaced apart from the roof 5 of the vehicle, for the reasons described herein, and also allows the rack 110 to be mounted on vehicles with curved or arched roofs, instead of flat roofs 5 as shown. The leg 152 can slide within the opening 148 of the framework connector receiver 146, allowing the framework connector receiver 146 to move to one of the different positions on the leg 152. In the illustrated embodiment, the leg 152 includes indicia 154 (e.g., lines) at equally spaced intervals there along. The indicia 154 provides a reference for the user on the leg 152 so that the use can properly position the framework connector 142 relative to the framework connector receiver 146 (e.g., position the framework 112 to have the desired amount of clearance between itself and the roof 5 of the vehicle 1). The rest 150 is rigidly coupled to the framework 112 (e.g., the solar panel support 114). The leg 152 may be secured to the framework with fasteners 136 (e.g., self-tapping screws), as shown, or by welding, or any other suitable means. In the illustrated embodiment, the framework connector receiver 146 defines openings through which the fasteners 136 extend through and into the leg 152. The fasteners 136 allow the framework connector receiver 146 to be secured to the leg 152 at generally any position thereon. In the illustrated embodiment, the leg 152 comprises a length of metal (e.g., steel, aluminum, etc.) tubing, although other configurations are within the scope of the present disclosure. The framework connector 142 may also include a brace 156 extending between the leg 152 and the rest 150 to strengthen and stiffen the framework connector 142. In another embodiment, the framework connectors may be rigidly fixed to the mounting base. For example, the framework connectors can be welded to the mounting base, such as directly to the vehicle mounting member. In this embodiment, the user may position the mounting base relative to the vehicle 1 in order to obtain the desired amount of clearance between the framework 112 and the vehicle. In this embodiment, the vehicle mounting member may be one piece or multiple separate pieces. For example, in this embodiment, the vehicle mounting member could comprise a plurality of spaced apart vehicle mounting member segments, each segment fixed to one of the framework connectors.

To install the rack 110 on the vehicle 1, the user mounts the first and second framework supports 138 on the vehicle 1. The mounting base 140 of the first framework support 138 is mounted on one side 6 of the vehicle 1 using the fasteners 136 and the mounting base 140 of the second framework support 138 is mounted on the other side 7 of the vehicle 1 using the fasteners 136. The mounting bases 140 (broadly, the first and second framework supports 138) are mounted directly across from each other on the vehicle 1. The framework connectors 142 of the first and second framework supports 138 are then connected to their respective mounting base 140. The user inserts the leg 152 of each framework connector 142 into the opening 148 of one of the framework connector receivers 146. After the user positions the framework connector 142 (e.g., the leg 152) at the desired position relative to the framework connector receiver 146, the user secures and fixes the framework connector 142 to the framework connector receiver 146 using the fasteners 136. The user positions the framework connector 142 relative to the framework connector receiver 146 so that the framework will have the desired clearance with the roof 5 of the vehicle 1. This process repeats until the framework connectors 142 of the first and second framework supports 138 are mounted to their respective mounting base 140.

After, the user mounts the framework 112 onto the first and second framework supports 138. Each solar panel support 114 is coupled to a framework connector 142 of the first framework support 138 and a framework connector 142 of the second framework support 138. The two framework connectors 142 each solar panel support 114 is coupled to are directly across from each other on the vehicle 1. The user mounts each solar panel support 114 on the framework connectors 142 by inserting the rest 150 of each framework connector 142 into the channel 116. The length of solar panels supports 114 (broadly, the width W_{F} of the framework 112) is constant. However, different vehicles 1 have different widths W_{T}. By being able to mount and connect the solar panel supports 114 at different positions on the two framework connectors 142 (e.g., rest 150), framework connectors 142 (broadly, the first and second framework supports 138) can be connected to the solar panel supports 114 generally regardless of the relative locations of the mounting bases 140 on the vehicle 1 (e.g., generally regardless of the distance between first and second framework supports 138 set by the width W_{T} of the vehicle 1). This allows the framework 112 to be mounted on vehicles 1 of generally any width W_{T}, regardless of the size (e.g., width W_{F}) of the framework 112. After the solar panel supports 114 are position on the framework connectors 142, the user secures these components together using the fasteners 136. The solar panel supports 114 can defining openings through which the fasteners 136 extend through to engage the framework connector 142.

After, the user mounts the solar panels P on the framework 112. The user positions each solar panel P in the fixed solar panel clips 120. The user then positions the adjustable solar panel clips 118 on the solar panels P and secures the adjustable solar panel clips 118 to the corresponding solar panel support 114 using the fasteners 136. The rack 110 is now fully assembled and supports the two solar panels P on the vehicle. If desired and if the vehicle has enough space, the user can position another rack 110 on the vehicle 1, in an end-to-end relationship to support additional solar panels. Alternatively, the mounting bases 140 could be lengthened and more framework connectors 142, framework connector receivers 146, solar panels supports 114, etc., added to support additional solar panels P with the one rack 110.

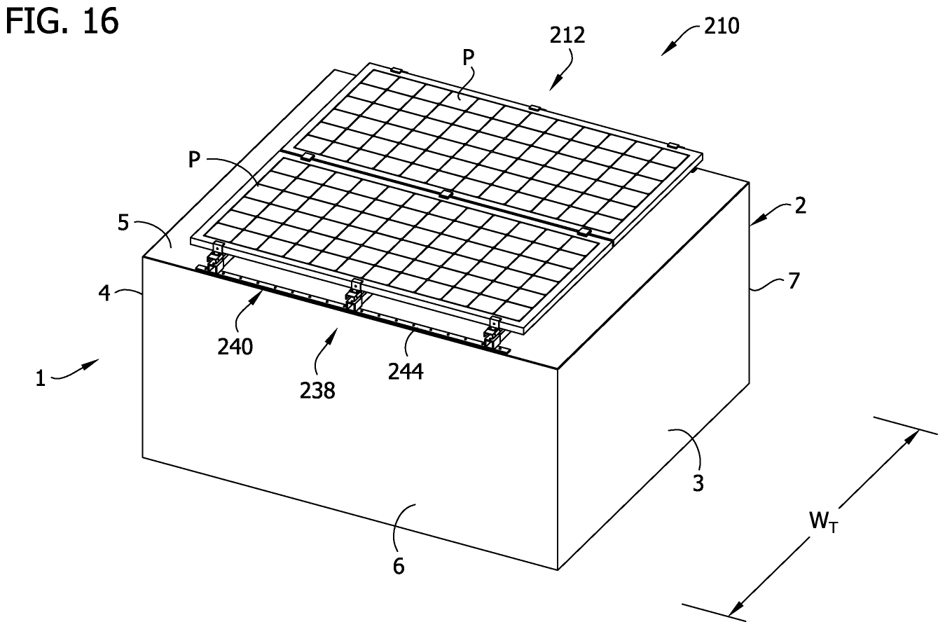

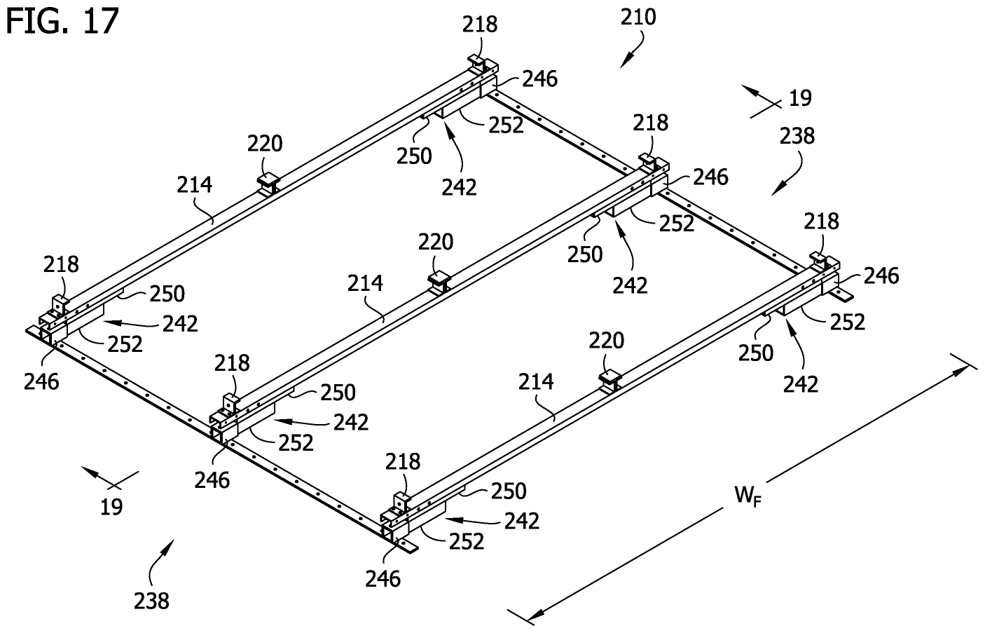

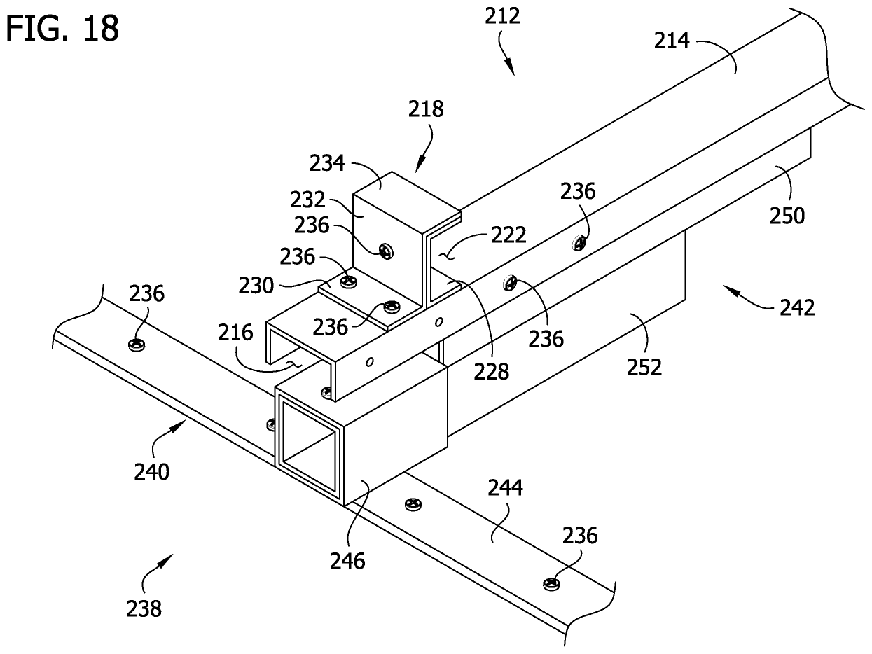

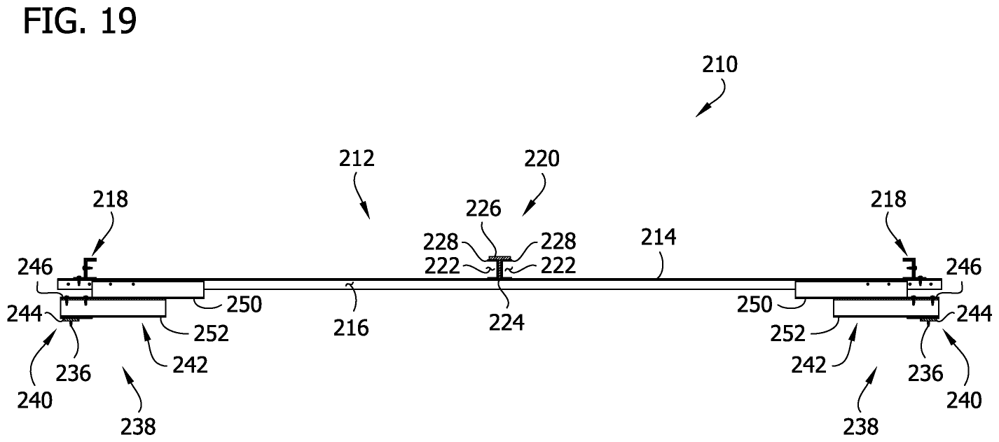

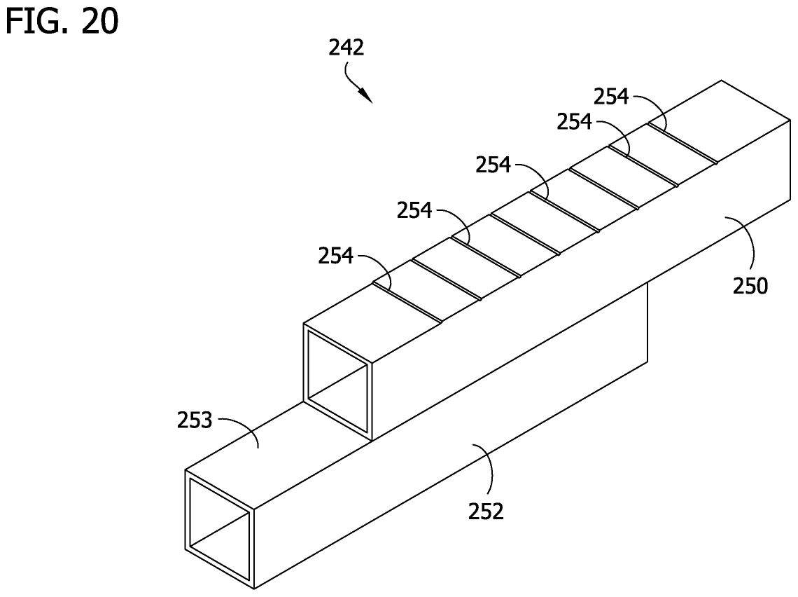

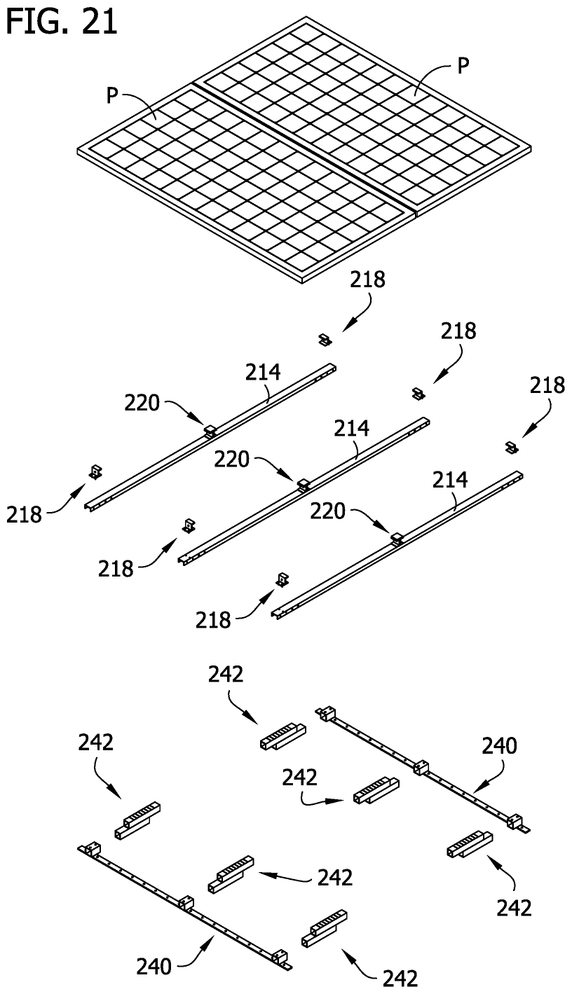

Referring to FIGS. 16-21, another example of a solar panel rack (e.g., rack) according to the teachings of the present disclosure is generally indicated at reference numeral 210. The rack 210 of FIGS. 16-21 is generally analogous to the rack 110 of FIGS. 9-15 and, thus, for ease of comprehension, where similar, analogous or identical parts are used, reference numerals “100” units higher are employed. Accordingly, unless clearly stated or indicated otherwise, the above descriptions regarding the rack 110 of FIGS. 9-15 also apply to the rack 210 of FIGS. 16-21. For example, the framework 212 of the rack 210 of FIGS. 16-21 is identical to the framework 112 of the rack 110 of FIGS. 9-15.

In this embodiment, the rack 210 is configured to attach to a generally flat roof 5 of a vehicle 1. The first and second framework supports 238 are mounted on the roof 5 of the vehicle 1. The framework supports 238 includes framework connectors 242 having a generally Z-shape. Each framework connector 242 includes the rest 250 and the leg 252. In this embodiment, the rest 250 and the leg 252 are generally horizontal and parallel to one another. The rest 250 overlies or is stacked on the leg 252. This stacking spaces the framework 212 from the roof 5 of the vehicle 1, for the reasons described herein. The leg 252 includes an end portion 253 that extends outward of an end of the rest 250 that is inserted into the framework connector receiver 246 of the mounting base 240. The end of the rest 250 can engage the framework connector receiver 246 to act as a stop and set the position of the end portion 253 of the leg 252 in the framework connector receiver 246. Thus, the framework connector receiver 246 and the leg 252 are connected at generally only one position on the leg 252 (e.g., the position where the rest 250 engages the framework connector receiver 246).

In this embodiment, the framework 212, and the mounting bases 240 of the rack 210 of FIGS. 16-21 are identical to the framework 112 and the mounting bases 140 of the rack 110 of FIGS. 9-15. Accordingly, the racks 110, 210 of FIGS. 9-21 can be configured to be mounted on either the sides 6, 7 or roof 1 of the vehicle 1 depending on which type of framework connector 142, 242 the user selects. For example, in one embodiment, the user may be provided with a rack kit including one framework 112, 212, two mounting bases 140, 240, a plurality of framework connectors 142 of FIGS. 9-15, and a plurality of framework connectors 242 of FIGS. 16-21 and the user selects which framework connectors 142, 242 to use based on whether the rack 110, 210 is mounted on the sides 6, 7 or the roof 5 of the vehicle 1.

Various objects and advantages of the present disclosure is thus apparent from the description herein taken in conjunction with the accompanying drawings wherein, by way of illustration and example, certain embodiments of this disclosure are set forth. The drawings submitted herewith constitute a part of this specification, include exemplary embodiments of the present disclosure, and illustrate various objects and features thereof.

Modifications and variations of the disclosed examples are possible without departing from the scope of the disclosure defined in the appended claims. For example, where specific dimensions are given, it will be understood that they are exemplary only and other dimensions are possible.

When introducing elements of the present disclosure or the example(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above constructions, products, and methods without departing from the scope of the present disclosure, it is intended that all matter contained in the above description and shown in the accompanying drawings shall be interpreted as illustrative and not in a limiting sense.

What is claimed is:

1. A rack for mounting one or more solar panels on a vehicle, the rack comprising:
a framework configured to couple to and support the one or more solar panels, the framework having opposite first and second sides and a width between the first and second sides;
a first framework support configured to attach to the vehicle, the first framework support including a first framework connector configured to couple to the first side of the framework; and
a second framework support configured to attach to the vehicle at a location spaced apart from the first framework support, the second framework support configured to couple to the second side of the framework;
wherein the first framework connector defines a first plurality of different coupling locations for the first side of the framework to couple to in order to accommodate the width of the framework when the first and second framework supports are attached to the vehicle.

2. The rack of claim 1, wherein the first framework support includes at least one additional first framework connectors, each of said at least one additional first framework connector configured to couple to the first side of the framework and defining a first plurality of different coupling locations for the first side of the framework to couple to in order to accommodate the width of the framework when the first and second framework supports are attached to the vehicle.

3. The rack of claim 1, wherein the second framework support includes a second framework connector configured to couple to the second side of the frame.

4. The rack of claim 2, wherein the first framework support includes a mounting base configured to couple to the vehicle, the plurality of first framework connectors configured to be connected to the mounting base.

5. The rack of claim 3, wherein the second framework connector defines a second plurality of different coupling locations for the second side of the framework to couple to in order to accommodate the width of the framework when the first and second framework supports are attached to the vehicle.

6. The rack of claim 1, wherein the first framework connector includes an elongate rest defining the first plurality of different coupling locations, the elongate rest arranged to engage and support the framework when the first framework connector is coupled to the first side of the framework.

7. The rack of claim 6, wherein the framework defines a channel, the rest sized and shaped to be received by the channel so that the framework can move relative to the rest to accommodate the width of the framework when the first and second framework supports are attached to the vehicle.

8. The rack of claim 1, wherein the first framework support includes a mounting base configured to couple to the vehicle, the first framework connector configured to be connected to the mounting base.

9. The rack of claim 8, wherein the mounting base includes a framework connector receiver configured to receive and connect to the first framework connector.

10. The rack of claim 9, wherein the framework connector receiver is connectable to the first framework connector at a plurality of different positions on the first framework connector.

11. The rack of claim 10, wherein the framework connector receiver defines an opening and the first framework connector includes a leg, the leg sized and shaped to be inserted into the opening and move within the opening to connect the framework connector receiver to the first framework connector at one of the plurality of different positions.

12. The rack of claim 7, wherein the mounting base includes a vehicle mounting member configured to be coupled to a roof of the vehicle or to a side of the vehicle.

13. The rack of claim 12, wherein the mounting base includes a sealer configured to form a seal with the vehicle when the mounting base is coupled to the vehicle.

14. The rack of claim 1, wherein the framework includes a solar panel support configured to support at least one of the one or more solar panels.

15. The rack of claim 14, wherein the solar panel support is configured to be connected to the first framework connector, the solar panel support defining a channel sized and shaped to receive the first framework connector when the solar panel support is connected to the first framework connector.

16. The rack of claim 14, wherein the framework includes an adjustable solar panel clip configured to be connected to the solar panel support and to engage at least one solar panel of the one or more solar panels to secure said at least one solar panel to the framework.

17. The rack of claim 16, wherein the adjustable solar panel clip is configured to be connected to the solar panel support at a plurality of different positions on the solar panel support to accommodate a size of said at least one solar panel.

18. The rack of claim 16, wherein the adjustable solar panel clip includes a pad configured to engage and cushion said at least one solar panel when the adjustable solar panel clip secures said at least one solar panel to the framework.

19. The rack of claim 17, wherein the framework includes a fixed solar panel clip fixedly mounted on the solar panel support and configured to engage said at least one of the solar panel to secure said at least one solar panel to the framework.

20. A rack kit for mounting one or more solar panels on a vehicle, the rack kit comprising:
a first mounting base configured to be mounted to the vehicle;
a second mounting base configured to be mounted to the vehicle at a location spaced apart from the first mounting base;
a plurality of framework connectors configured to couple to either the first mounting base or the second mounting base;
a plurality of solar panel supports configured to be coupled to two of the plurality of framework connectors; and
a plurality of solar panel clips configured to secure the one or more solar panels to the plurality of solar panel supports.
